(19) United States
(12) Patent Application Publication
(10) Pub. No.: US 2017/0004278 A1
(43) Pub. Date: Jan. 5, 2017

(54) SYSTEM AND METHOD FOR SPARSE PRESSURE/FLOWRATE REDUCED MODELING OF HEMODYNAMICS

(71) Applicants: The Board of Trustees of the Leland Stanford Junior University, Stanford, CA (US); The Regents of the University of California, Oakland, CA (US)

(72) Inventors: Alison L. Marsden, La Jolla, CA (US); Daniele E. Schiavazzi, Mountain View, CA (US)

(21) Appl. No.: 15/199,824

(22) Filed: Jun. 30, 2016

Related U.S. Application Data
(60) Provisional application No. 62/186,776, filed on Jun. 30, 2015.

(51) Int. Cl. G06F 19/00; G06F 17/50

(52) U.S. Cl. CPC G06F 19/3437; G06F 17/5018

(57) ABSTRACT

Computational models of heart activity and blood flow are gaining considerable application in medical research but are computationally complex and not well suited to clinical applications where patient specific factors need to be accounted for to render more actionable care decisions. Given here is a surrogate for traditional complex 3D heart-flow modeling that allows for a less costly and faster decision making system in the clinic. An approximation of the heart flow may be used such that low cost and high speed modeling can be realized in the clinic.

### CROSS-REFERENCE TO RELATED APPLICATIONS

This application claims benefit of priority of U.S. Provisional Patent Application Ser. No. 62/186,776, filed Jun. 30, 2015, and the same is incorporated by reference herein in its entirety.

### GOVERNMENT FUNDING

This invention was made with government support under OCI-1150184 awarded by the National Science Foundation-Faculty Early Career Development (CAREER) Program, R01HL123689 awarded by the National Institutes of Health and ACI-1053575 awarded by the Extreme Science and Engineering Discovery Environment (XSEDE), supported by National Science Foundation. The government has certain rights in the invention.

### BACKGROUND

Cardiovascular models are currently used to noninvasively predict the severity of various vascular abnormalities, e.g., determination of hemodynamic significant stenosis in coronary and peripheral vascular disease, as well as for surgical planning in acquired and congenital cardiovascular disease. However, the associated computational cost poses severe limitations to the use of data assimilation techniques on these models, such techniques having the aim of better representing physiology and specific patients.

In more detail, three-dimensional simulations of vascular hemodynamics are widely used, with increasing clinical implications, in applications ranging from pediatric cardiology to coronary artery and aneurysm hemodynamics. Before these models can be used to complement clinical decision making, their geometry, material properties and boundary conditions need to be estimated from clinical data. Unfortunately, the significant computational cost severely limits inclusion of these models in the parameter estimation, uncertainty quantification and optimization procedures (all requiring repeated model evaluations), needed to produce reasonable patient specific estimates of the input data.

Multiscale cardiovascular models are an example of state-of-the-art tools in hemodynamic prediction, and the same couple three-dimensional discrete finite element simulations with a lumped parameter description of the patient circulation. Lumped parameter models, obtained by linearized Navier-Stokes equations around rest conditions [23], are described through systems of ordinary differential equations (ODEs) analogous to those describing the evolution of current and voltage in an electrical circuit. These methodologies use a resistance/capacitive/inductance layout to determine the equivalent properties of the patient circulatory system. Seen from a finite element modeling perspective, such multi-scale models belong to two main families, which can be characterized as having open or closed loop boundary conditions. Open loop boundary conditions consist of simplified layouts with lumped circulation elements (e.g., resistance, RCR blocks, etc.), connecting one of the model outlets with locations of prescribed distal pressure time histories, as well as prescribed flow rates at one or more inlets. Closed loop circulation models instead include heart function, and do not necessitate any prescribed inlet flow.

Tuning these models in order to have outputs consistent with clinically measured quantities is generally a time consuming operation requiring significant operator input. In addition, to minimize the computational cost associated with the solution of these models, the 3D model is replaced with a resistance layout by making an a priori assumption about the possible interaction between the inlets/outlets. Existing methodologies based on resistive surrogates often require manual or semiautomatic tuning of resistive blocks to match the response of the three-dimensional model whose reduced representation is sought.

While several techniques for parameter estimation and data assimilation in lumped circulation networks are proposed in the literature, the computational cost of solving the finite element discrete vasculature prevents extensions of these techniques to complete multiscale models.

### SUMMARY

Systems and methods according to present principles provide a computational procedure to create a stable and lightweight surrogate of an otherwise computationally-expensive 3-D finite element model, to be used within OD/1D circulation models, at a reduced computational cost.

In more detail, methodologies according to present principles model behavior of 3-D anatomical vasculature using an outlet pressure flow rate approximation, i.e., the methodologies represent the 3-D model as a relationship between outlet flow rates and pressures. The same may also employ sparse regression (relevance vector machines) to build model surrogates that are stable to pressure fluctuations.

In one implementation, the disclosed systems and methods provide a tool to replace a computationally expensive 3D vascular model with a lightweight surrogate, by preserving the exchange of information in terms of pressure-flow rate at the inlets/outlets. This reduced representation is ideal to be included in existing lumped parameter (OD) models simulating the peripheral circulation of specific patients. Systems and methods create a lumped circulation model based on a 3-D model of vasculature and the systems and methods create a finite element model and a boundary circulation network, with coupling occurring at their interface, such that pressure and flow rate information is exchanged at at least one, and in many cases every, solution time step.

In one implementation, the outlet pressure/flow rate information may be approximated by outlet pressure/flow rate polynomial surrogates. The method may further include computing a maximum likelihood estimate for coefficients of the polynomial, or using relevance vector machines to promote sparse coefficient representations through properly selected hyperpriors. The method offers a systematic way to create lightweight surrogates from 3D models of the patient vasculature, either using the inlet/outlet pressures or flow rates as dependent variables.

Systems and methods according to present principles contemplate at least cases where the OD model provides interface pressures as inputs to a 3D model and receives the associated flow-rates, in cases where the OD model provides interface flow-rates and receives associated pressures.

In one aspect, the invention is directed towards a method for modeling behavior of 3D anatomical vasculature, including: loading into a first computer memory data from a file indicative of a model of a patient's vasculature; loading into a second computer memory data from one or more files indicative of a set of standard parameters indicative of pressure and flow rate characteristics of the vasculature; calculating a first circulation solution for the model of the patient's vasculature using the data from the second computer memory and the data from the first computer memory, the first circulation solution including a solution for pressure, a solution for flow rate, or both; calculating coefficients of a sparse polynomial representation of patient hemodynamics based on the first calculated circulation solution, and creating a surrogate file with the calculated coefficients; loading into a third computer memory a minimized model of the patient's vasculature using the calculated coefficients from the surrogate file; receiving one or more data from one or more respective health monitoring sensors, and modifying the minimized model based on the received one or more data; calculating a second circulation solution for the minimized model; and determining one or more clinical indications from the calculated second circulation solution, and displaying a representation of the determined indication on a user interface.

Implementations of the invention may include one or more of the following. The loading into a first computer memory data from a file indicative of the model of a patient's vasculature may include receiving an image file of the patient's vasculature, and creating a 3D model of the patient's vasculature based on the received image file. The loading into a first computer memory data from a file indicative of the model of a patient's vasculature may include receiving data from an MRI machine. The method may further include the step of correlating the second circulation solution with a velocity distribution from the received data from the MM machine. The set of standard parameters may be from a standard peripheral circulation model. The step of calculating the coefficients may be performed using a relevance vector machine (RVM) methodology.

In another aspect, the invention is directed towards a non-transitory computer readable medium, including instructions for causing a computing environment to perform the above method.

In another aspect, the invention is directed towards a method for modeling behavior of 3D anatomical vasculature using an outlet pressure-flow rate approximation, including: creating a lumped circulation model based on a 3D model of vasculature; and creating a finite element model and a boundary circulation network, with coupling occurring at an interface between the finite element model and the boundary circulation network, and such that data indicative of pressure/flow rate information is exchanged at at least one solution time step.

Implementations of the invention may include one or more of the following.

The data indicative of outlet pressure/flow rate information may be approximated by outlet pressure/flow rate functional surrogates. The method may further include using a sparse regression approach to promote small expansion coefficients through properly selected hyperpriors. The sparse regression approach may include using relevance vector machines. The method may further include receiving the 3D model of vasculature, and performing the step of creating the lumped circulation model from the received 3D model. The lumped circulation model may receive outlet flow rates from the finite element model and the lumped circulation model may further provide pressure information back at respective outlets for a subsequent time step. The 3D model may receive outlet pressures from the lumped circulation model and the method may further include providing an updated local distribution of pressures and velocities, resulting in new outlet flow rates. The finite element model and the boundary circulation network exchange pressure and flow rate information, such that the lumped circulation model is reduced while preserving the exchange of information at the interface.

In another aspect, the invention is directed towards a non-transitory computer readable medium, including instructions for causing a computing environment to perform the above method.

Advantages of certain implementations of the invention may include one or more of the following. Systems and methods according to present principles are fast, can be fully automatic, and can provide a working surrogate for vasculature. In addition, the same generally do not require any a priori resistive layout to be assigned. Systems and methods according to present principles allow assimilation of multi-scale models at a fraction of the computational cost of prior systems. Other advantages will be apparent from the description that follows, including the specification and claims.

### BRIEF DESCRIPTION OF THE DRAWINGS

FIGS. 1A and 1B illustrates idealized circulation in the aorta, as seen by flow rate and pressure drop, respectively.

FIGS. 2A and 2B illustrates idealized circulation in the coronary arteries, as seen by flow rate and pressure drop, respectively.

FIGS. 3A and 3B show a model of the abdominal aorta as well as outlet nomenclature.

FIG. 4A shows the time history of aortic flow rate at the inlet. FIG. 4B illustrates an RCR layout.

FIGS. 5A-5H illustrate reconstructions of flowrates at abdominal aorta outlets using OLS.

FIGS. 6A-6H illustrate reconstructions of flowrates at abdominal aorta outlets using RVM.

FIG. 7 illustrates nomenclature used for outlets in a multi-scale coronary circulation model.

FIG. 8 illustrates a model representative of an aortic arch, and further showing a schematic representation of a simulated closed loop circulation model, including equivalent circuits.

FIGS. 9A-9H show multi-scale flow waveforms and regressions computed through OLS.

FIGS. 10A-10H show multi-scale flow waveforms and regressions computed through OLS.

FIGS. 11A-11D and 12A-12D indicate results comparing use of manually tuned resistances and the proposed RVM approximant for the coronary artery model.

FIGS. 13A-13D and 14A-14D indicate results comparing use of manually tuned resistances and the proposed RVM approximant for the abdominal aortic model.

FIGS. 15A-15D show outlet sensitivity matrices for abdominal aorta in coronary models.

FIG. 16A-16D illustrate that OLS regression produces larger amplification factors than RVM and therefore is likely to be less stable when included in ODE circulation models.

FIG. 17 is a flowchart according to one implementation of a method according to present principles.

FIG. 18 schematically illustrates a system according to present principles.

Like reference numerals refer to like elements throughout. Elements are not to scale unless otherwise noted.

### DETAILED DESCRIPTION

As noted above, cardiovascular simulation has shown potential value in clinical decision-making, providing a framework to assess changes in hemodynamics produced by physiological and surgical alterations. State-of-the-art predictions are provided by deterministic multiscale numerical approaches coupling 3D finite element Navier Stokes simulations to lumped parameter circulation models governed by ODEs. Development of next-generation stochastic multiscale models whose parameters can be learned from available clinical data under uncertainty, constitutes a research challenge made more difficult by the high computational cost typically associated with the solution of these models.

Systems and methods according to present principles provide ways to construct reduced representations that condense the behavior of 3D anatomical models using outlet pressure-flow polynomial surrogates, based on a population of multiscale model solutions spanning several heart cycles. This allows for parameter tuning and statistical estimation of high dimensional multiscale circulation models at a fraction of the computational cost. Relevance vector machine regression has been compared with maximum likelihood estimation, and it has been determined that sparse pressure/flow rate approximations offer superior performance in producing working surrogate models to be included in lumped circulation models/networks. Sensitivities of outlet flow rates are also quantified through a Sobol decomposition of their total variance encoded in the orthogonal polynomial expansion. Finally, augmented lumped parameter models including the proposed surrogates are used which accurately reproduce the response of multiscale models they were derived from. Results are presented for a model of the coronary circulation with closed loop boundary conditions and of the abdominal aorta with open loop boundary conditions.

Systems and methods according to present principles also characterize input quantities using probabilities, allowing the association of confidence metrics to simulation results, thus maximizing their predictive ability. In some cases this leads to a further increase on the number of simulations needed, for example, in the context of Bayesian estimation approaches. Particular details are disclosed in the provisional application from which a claim for benefit of priority is made, and which is incorporated by reference herein in its entirety.

Without wishing to be bound by theory, in one exemplary simulation according to present principles, a 3-D representation of the vasculature is partitioned into disjoint sets including walls, inlets, and outlets. Pressures and flow rates are characterized using random vectors with defined distributions. It can be shown that with appropriate assumptions and simplifications that the flow rate for a given inlet can be described by multivariate Legendre polynomials having coefficients that encode the flow rate statistics at a generic inlet or outlet. It can also be shown that the dependence between outlet pressures and the time derivative of the flow rate can be disregarded.

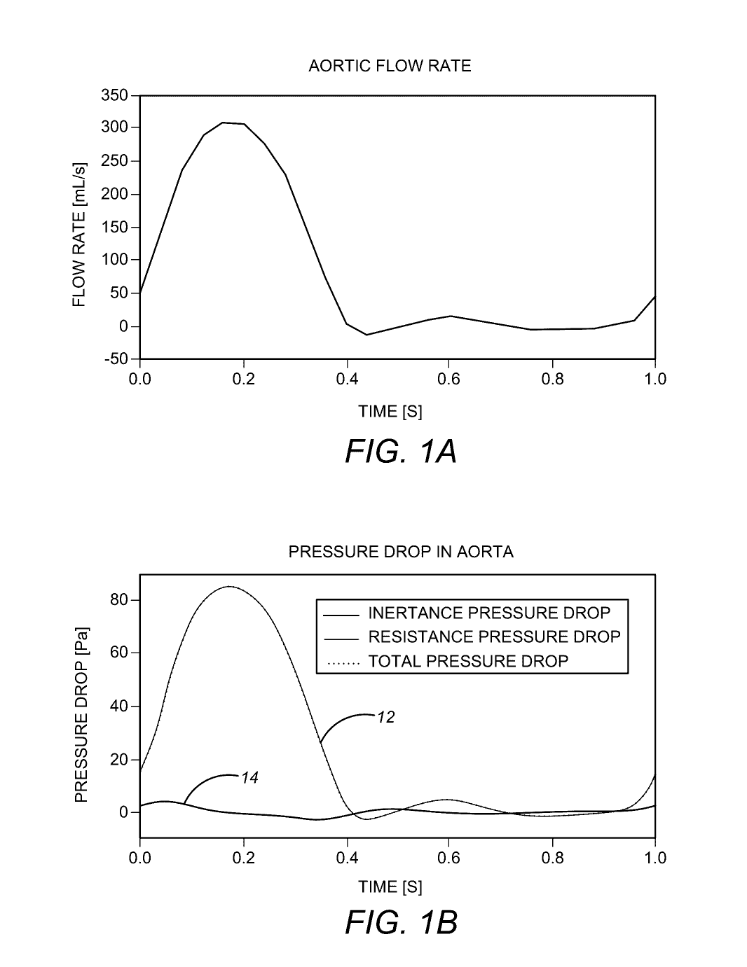

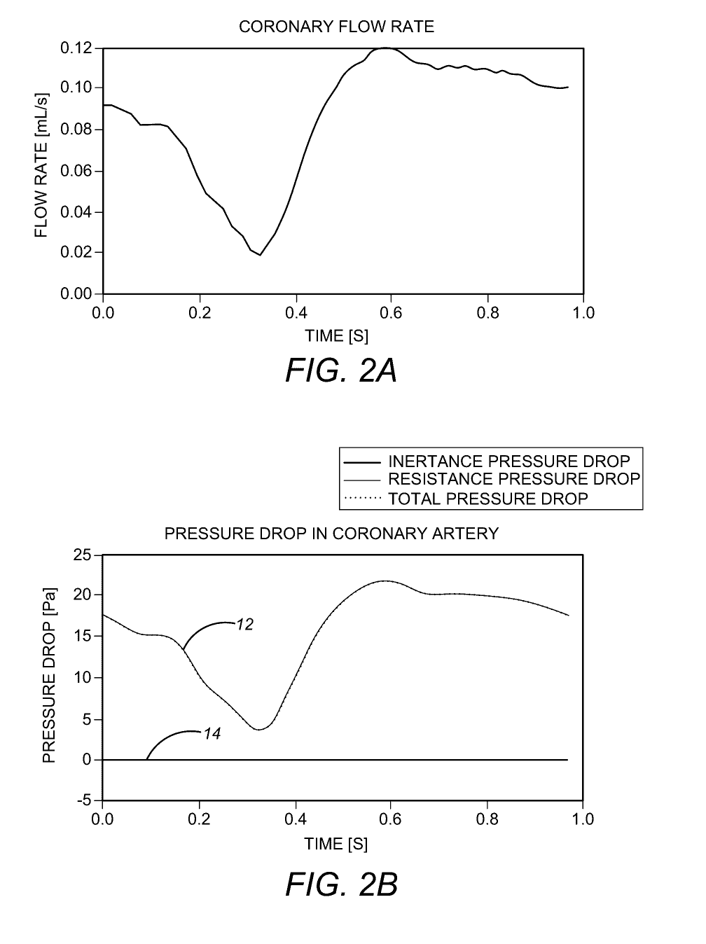

In particular, and referring to FIGS. 1A, 1B, 2A, and 2B, two different scenarios may be considered representing idealized circulation in the aorta and coronary arteries of a patient. For each scenario, an appropriate flow rate curve was selected and the contribution to the overall pressure drop was estimated as provided by the resistance and inertance (inductance, related to the time derivative of the flow rate) elements. As may be seen in the figures, the total pressure drop is dominated by the contribution 12 from resistance, as opposed to the inertance pressure drop shown by 14 (the total pressure drop is indicated by dots), supporting the choice to construct surrogates from outlet flow rates, neglecting terms related to their time derivative. Legendre expansions can be estimated using several approaches based on, e.g., information on the expected structure.

Two alternative methodologies are discussed here, characterized by different underlying assumptions. The first approach includes computing a maximum likelihood estimator (MLE) for the expansion coefficients. For a linear statistical model with constant-variance independent noise components, this is equivalent to minimizing the squared approximation error by ordinary least squares (OLS). In this approach, no assumption is made related to the expected structure of the expansion coefficients, thus allowing for possible interactions between all the outlets. In other words, using this approach, the pressure at every outlet may affect flow rate at an individual outlet.

The second approach uses a Relevance Vector Machine (RVM) methodology, and this approach promotes small expansion coefficients through specification of properly selected hyperpriors. This choice is motivated by the physical intuition that the flow rate at an outlet depends on the pressure distribution at only a limited number of other outlets.

In a preferred embodiment, RVMs may be employed over other widely used families of algorithms for sparse regression.

OLS and RVM were compared in performance in approximating flow rates from pressures at various outlets. In particular, two multiscale models representative of the open loop and closed loop boundary condition families were chosen, though the method is generally applicable. The agreement between the flow rates produced at every outlet by the reference multiscale solution and the computed reconstructions was investigated. The structure of the resulting representations was also investigated with the aim of highlighting how different procedures capture the pressure/flow interaction among various outlets.

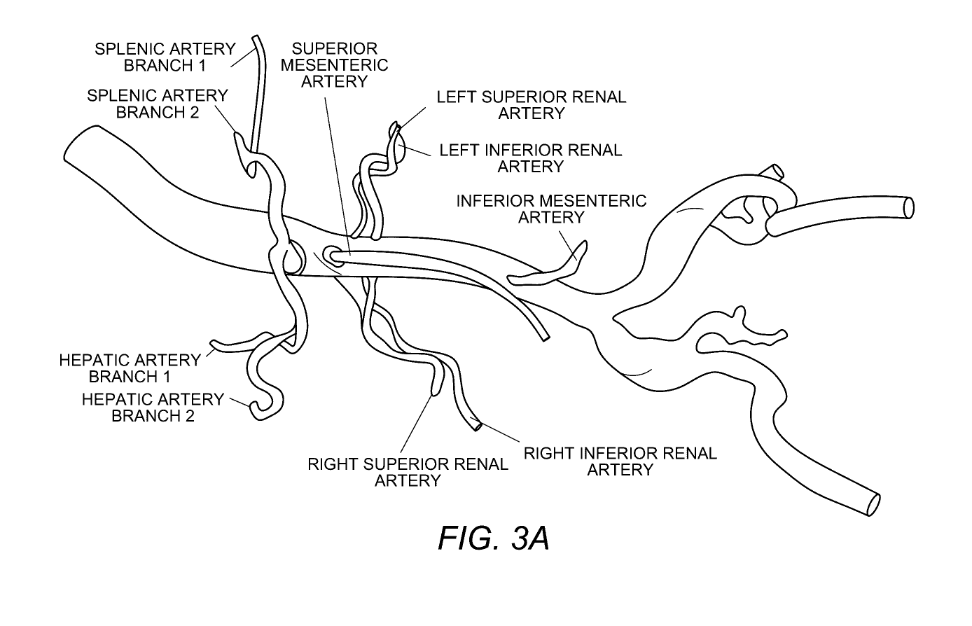

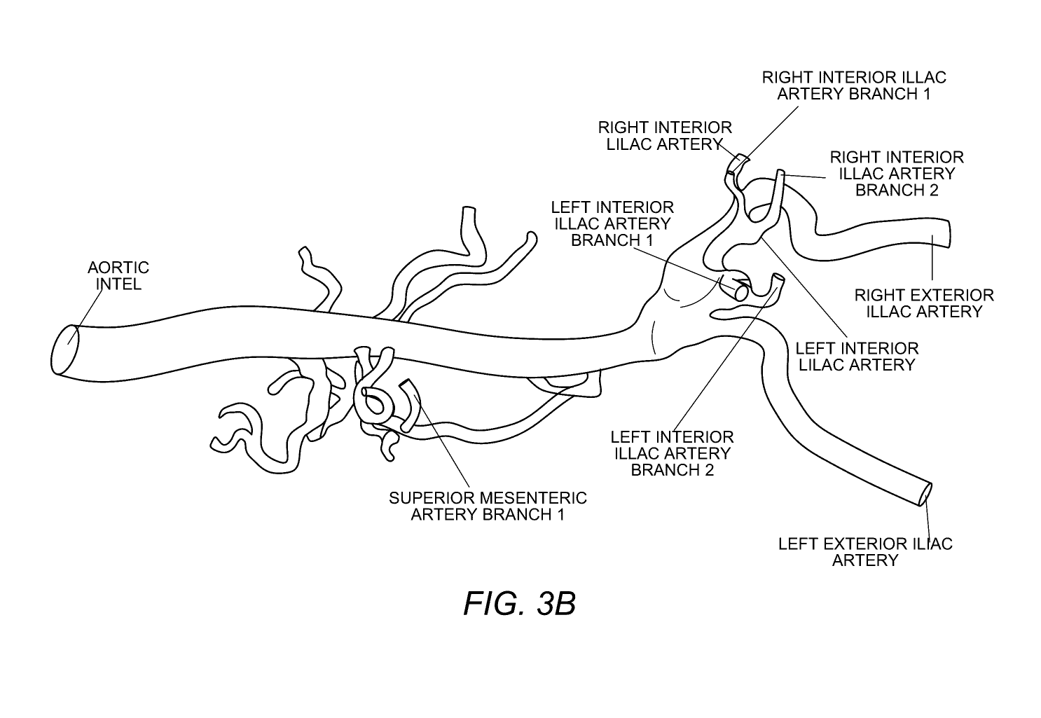

Abdominal Aortic Model with Open Loop Boundary Conditions (FIGS. 3-6)

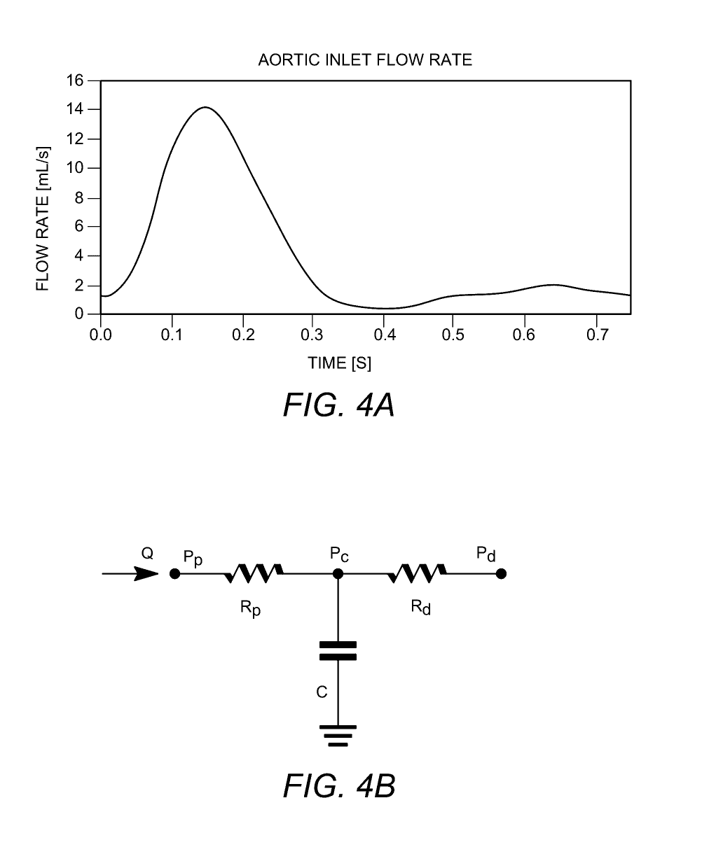

FIGS. 3A and 3B show a model of the abdominal aorta as well as outlet nomenclature. This model of the abdominal aorta was considered with boundary conditions provided by RCR blocks and prescribed inlet flow rates. The incompressible Navier-Stokes equations were solved using the open source package SimVascular for 7 heart cycles, using a timestep equal to 7.5×10−3 s under uniform blood density equal to 1.06 g·cm−3 and viscosity equal to 0.04 gr/cm/s. The three-dimensional SUPG finite element solver was implicitly coupled with RCR blocks at the 19 outlets. An RCR layout is illustrated in FIG. 4B, and the selected parameter set is shown in Table I below, which characterizes boundary RCR circulation block at every interface Γᵢ.

TABLE I

| i | Γᵢ | R_{F} [Ba · s/mL] | C [mL/Ba] | R_{d} [Ba · s/mL] | p_{d} |
|---|---|---|---|---|---|
| 1 | Inferior mesenteric artery | 1583.13 | 3.44 × 10⁻⁵ | 34215.40 | 0.0 |
| 2 | Right interior iliac artery | 3169.51 | 1.72 × 10⁻⁵ | 70363.10 | 0.0 |
| 3 | Right interior iliac artery branch 1 | 7094.64 | 7.7 × 10⁻⁶ | 157504.00 | 0.0 |
| 4 | Right interior iliac artery branch 2 | 7094.64 | 7.7 × 10⁻⁶ | 157504.00 | 0.0 |
| 5 | Left interior iliac artery branch 1 | 7094.64 | 7.7 × 10⁻⁶ | 157504.00 | 0.0 |
| 6 | Left interior iliac artery | 3903.05 | 1.40 × 10⁻⁵ | 86649.70 | 0.0 |
| 7 | Left interior iliac artery branch 2 | 7094.64 | 7.7 × 10⁻⁶ | 157504.00 | 0.0 |
| 8 | Right exterior iliac artery | 718.27 | 7.60 × 10⁻⁵ | 15945.20 | 0.0 |
| 9 | Left exterior iliac artery | 718.27 | 7.60 × 10⁻⁵ | 15945.20 | 0.0 |
| 10 | Superior mesenteric artery | 867.84 | 6.27 × 10⁻⁵ | 18429.90 | 0.0 |
| 11 | Left inferior renal artery | 829.38 | 6.56 × 10⁻⁵ | 17593.90 | 0.0 |
| 12 | Left superior renal artery | 1330.80 | 4.08 × 10⁻⁵ | 27260.40 | 0.0 |
| 13 | Superior mesenteric artery branch 1 | 1617.35 | 3.37 × 10⁻⁵ | 35259.30 | 0.0 |
| 14 | Right superior renal artery | 609.70 | 8.93 × 10⁻⁵ | 12991.00 | 0.0 |
| 15 | Right inferior renal artery | 2222.74 | 2.45 × 10⁻⁵ | 47359.60 | 0.0 |
| 16 | Splenic artery branch 1 | 2096.00 | 2.60 × 10⁻⁵ | 45000.00 | 0.0 |
| 17 | Splenic artery branch 2 | 2096.00 | 2.60 × 10⁻⁵ | 45000.00 | 0.0 |
| 18 | Hepatic artery branch 2 | 2096.00 | 2.60 × 10⁻⁵ | 45000.00 | 0.0 |
| 19 | Hepatic artery branch 1 | 2096.00 | 2.60 × 10⁻⁵ | 45000.00 | 0.0 |

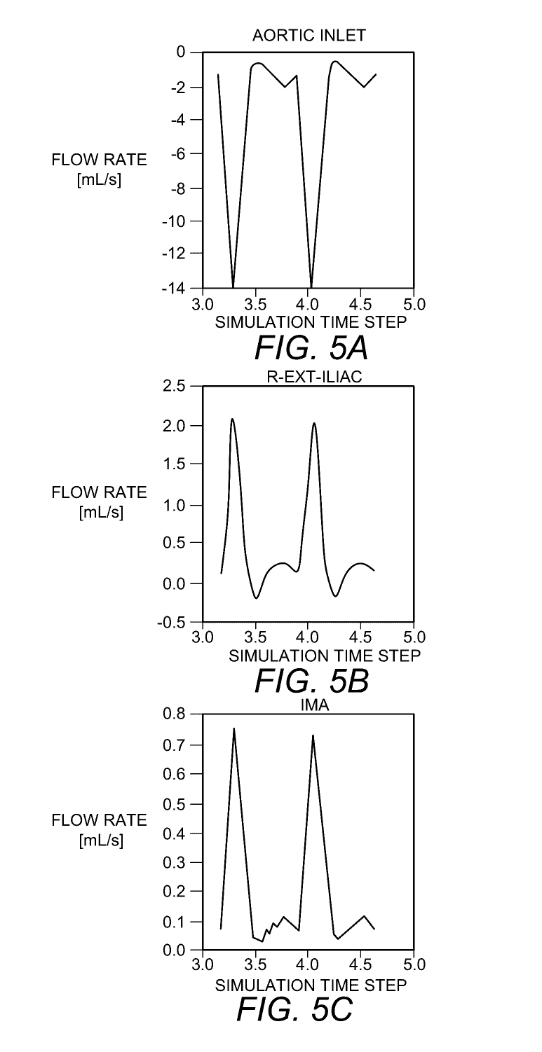

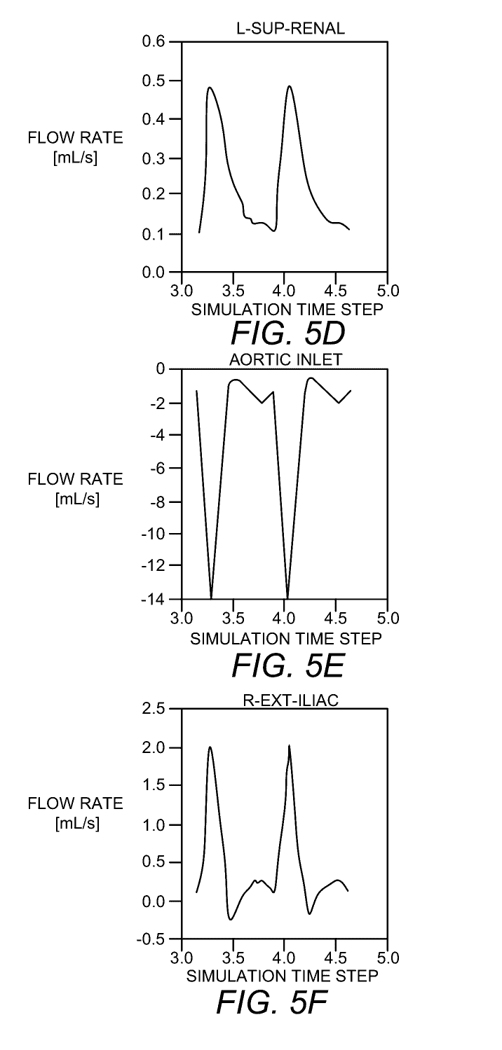

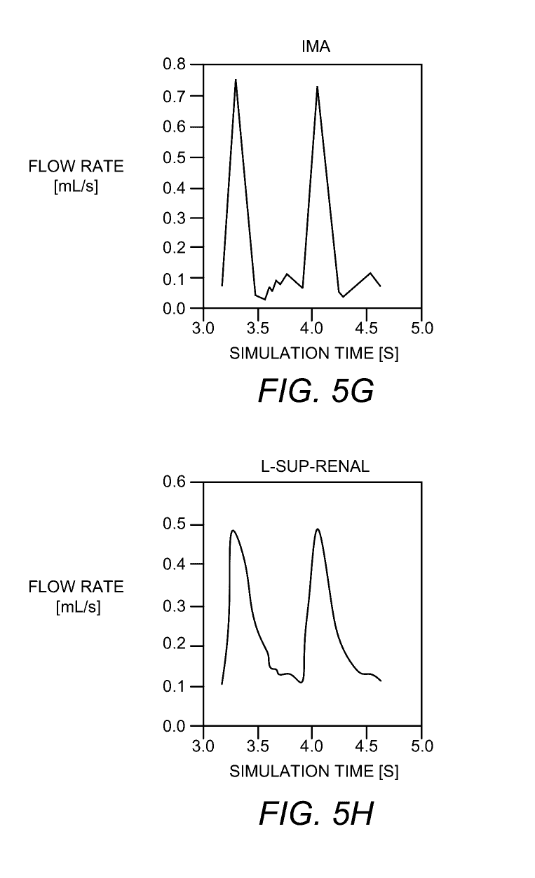

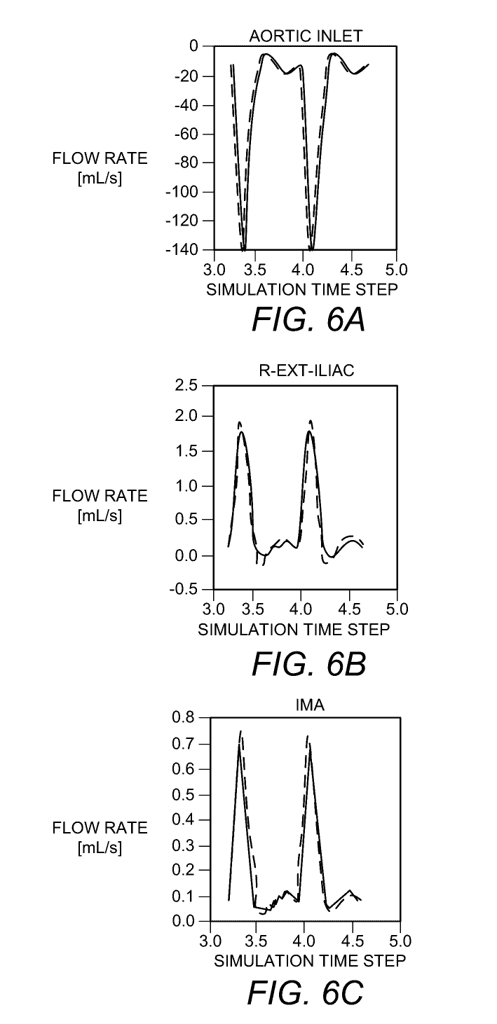

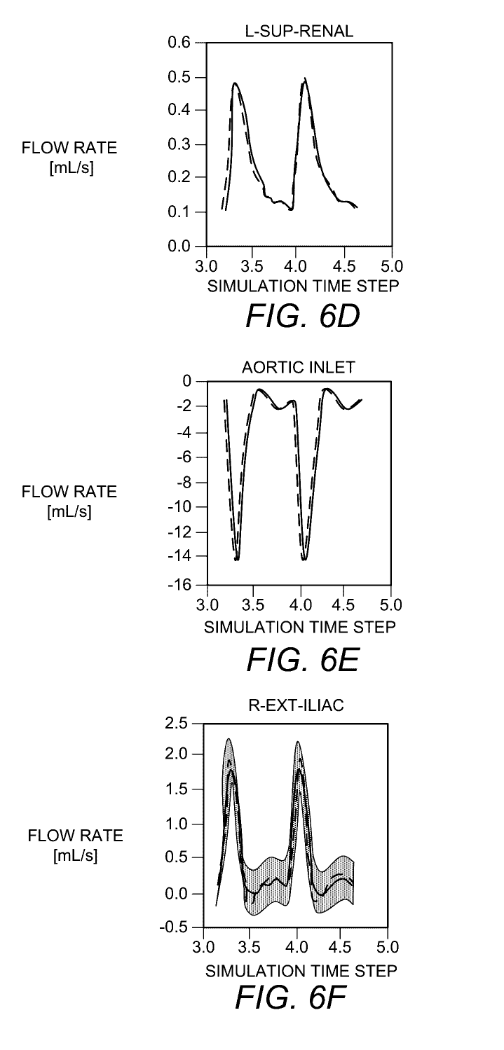

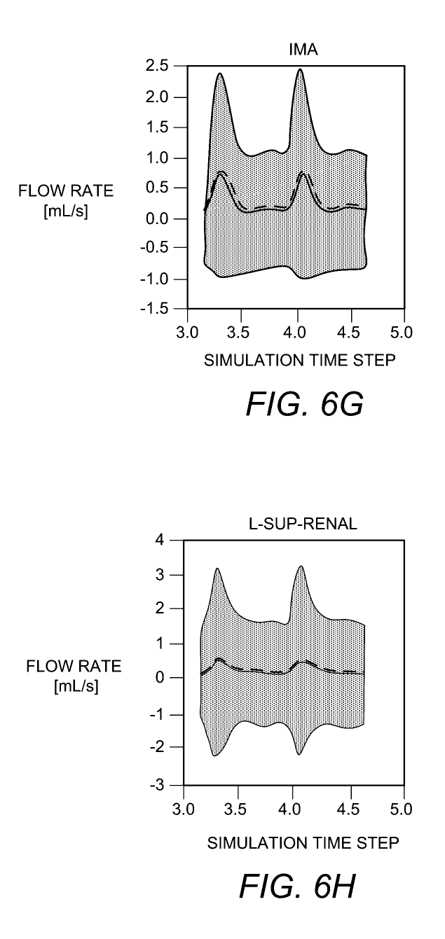

FIG. 4A shows the time history of aortic flow rate at the inlet, and the same was prescribed at the aortic inlet using a Womerseley flow profile. Flow rate reconstructions at the i^{th} interface Γᵢ, performed using both OLS and RVM, are illustrated in FIGS. 5A-5H and 6A-6H, respectively, which show reconstructions of flow rates at abdominal aorta outlets. Dashed lines represent open loop model flow rates while approximations are shown using continuous lines.

The shaded areas in the graph (see especially FIGS. 6F-6H) show 95% confidence intervals associated with the computed reconstructions determined using an amplification of the predictive variance. Reconstructions were performed under three different scenarios characterized by a sampling ratio equal to 0.05, 0.2 and 0.8, respectively. Average flow rates reconstructions were very similar for these scenarios, the main difference being the 95% confidence interval computed through RVM, as shown in FIG. 6 for the Inferior Mesenteric Artery (IMA) and left Superior Renal Artery, FIGS. 6C/6G and 6D/6H, respectively. OLS reconstructions appear affected by limited uncertainty, compared to those generated using RVM, in particular at the smaller outlets where small amplitude and high frequency oscillations can be observed, in particular during diastole.

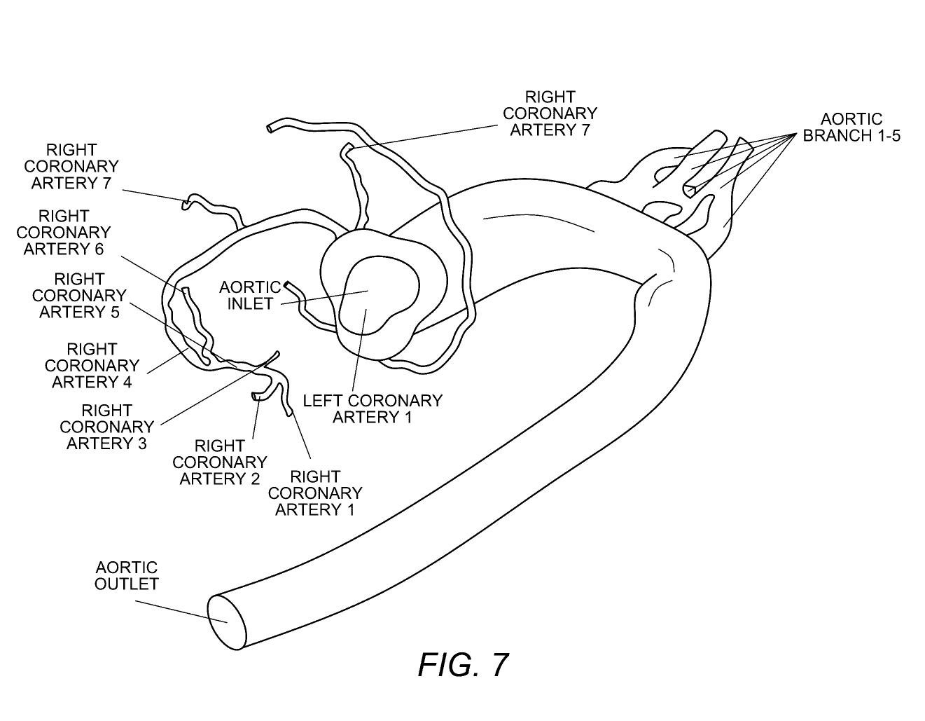

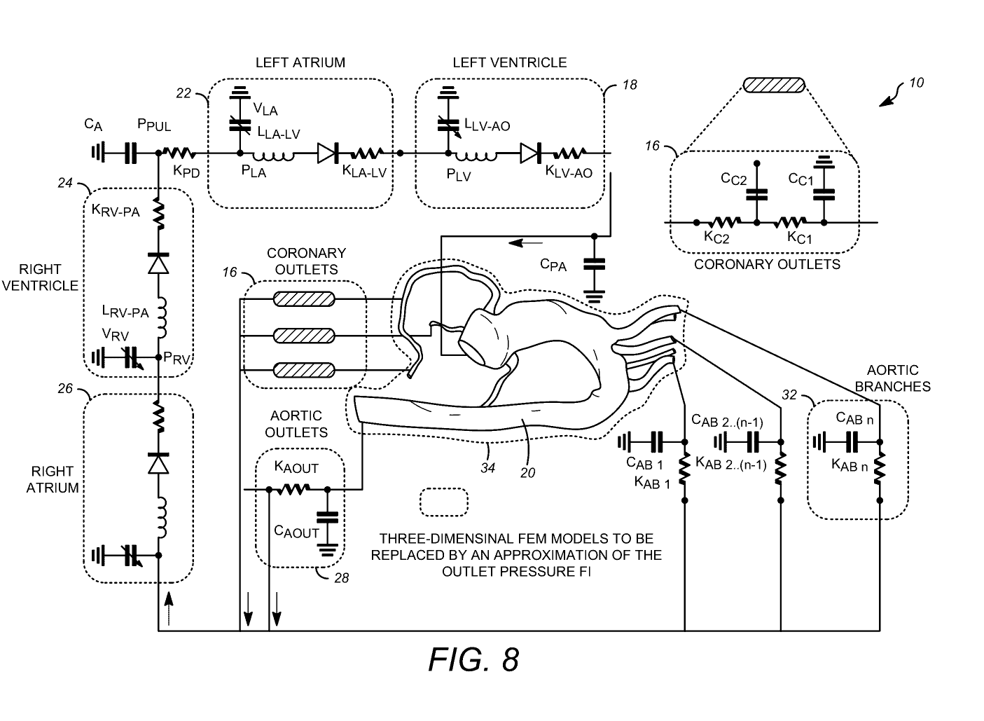

Coronary Circulation Model with Closed Loop Boundary Conditions (FIGS. 7-8)

A multiscale coronary circulation model was also constructed. The nomenclature used for the model outlets is illustrated in FIG. 7. The layout of the lumped parameter network model is shown in FIG. 8. In FIG. 8, a model 10 is representative of an aortic arch model 20 and the model indicates a schematic representation of the simulated closed loop circulation model used to investigate the characteristics of blood circulation in the coronary arteries. Equivalent circuits are shown for the coronary outlets 16, the left ventricle 18, the left atrium 22, the right ventricle 24, the right atrium 26, the aortic outlet 28, and the aortic branches 32. The portion indicated by the dotted line 34 indicates the three-dimensional FEM model that may be replaced by an approximation of the outlet pressure flow rate relationship.

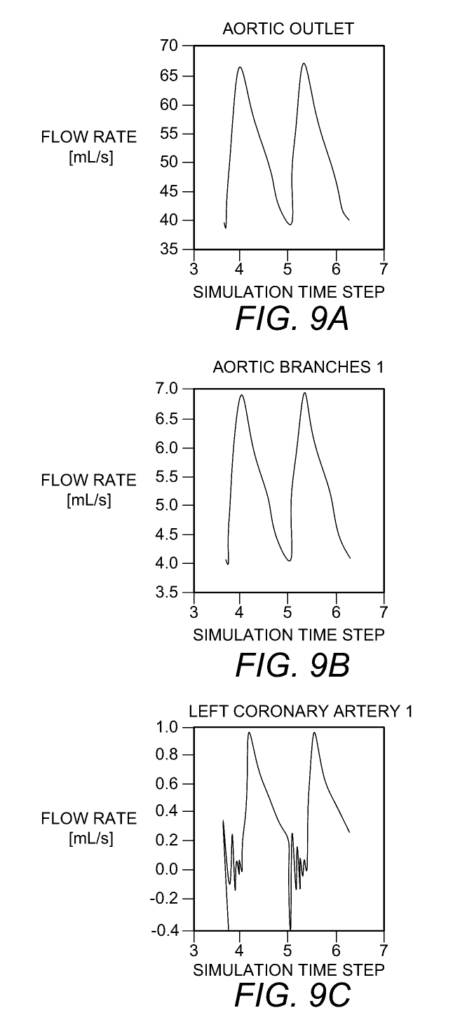

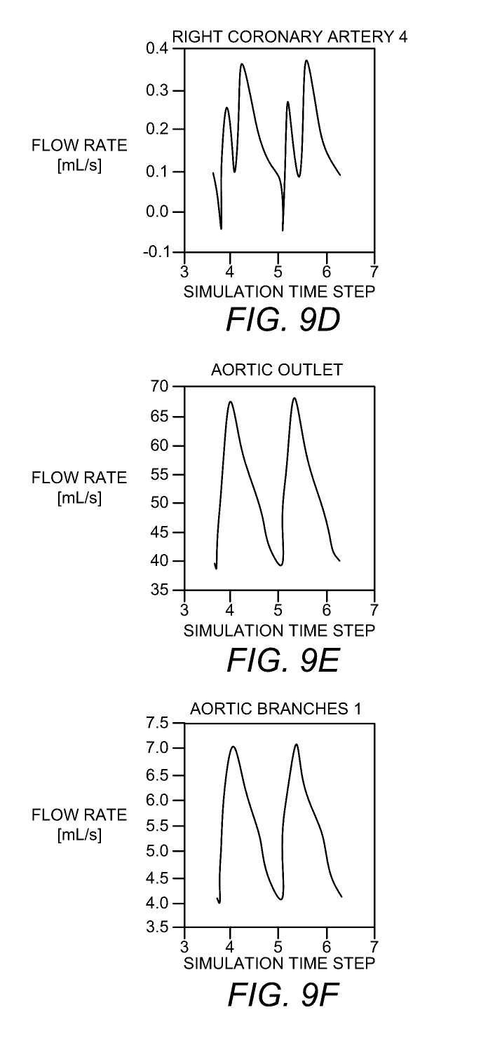

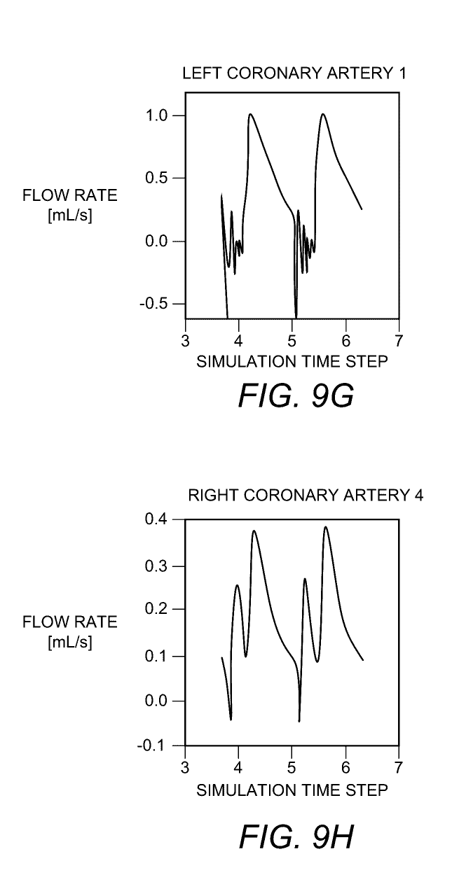

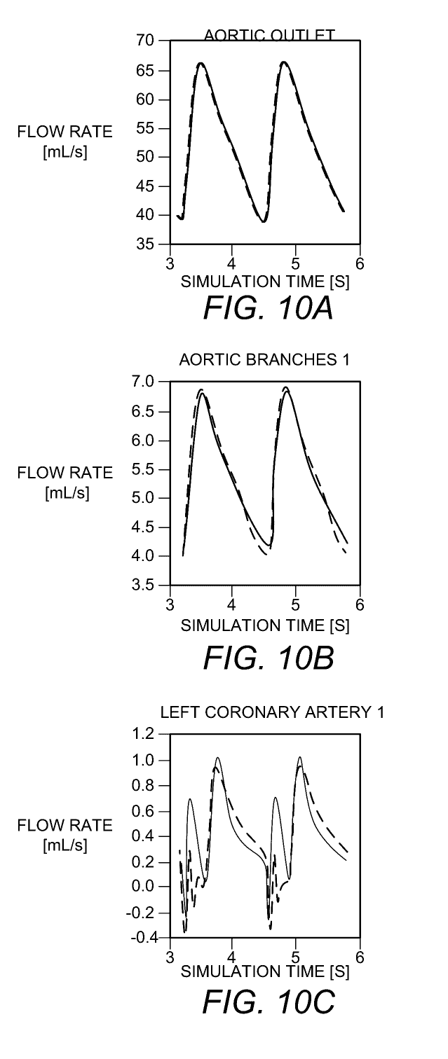

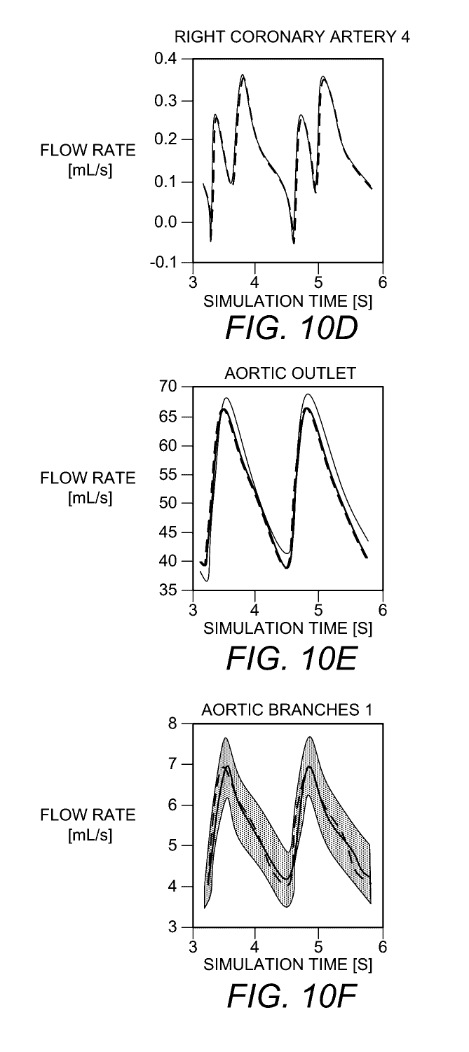

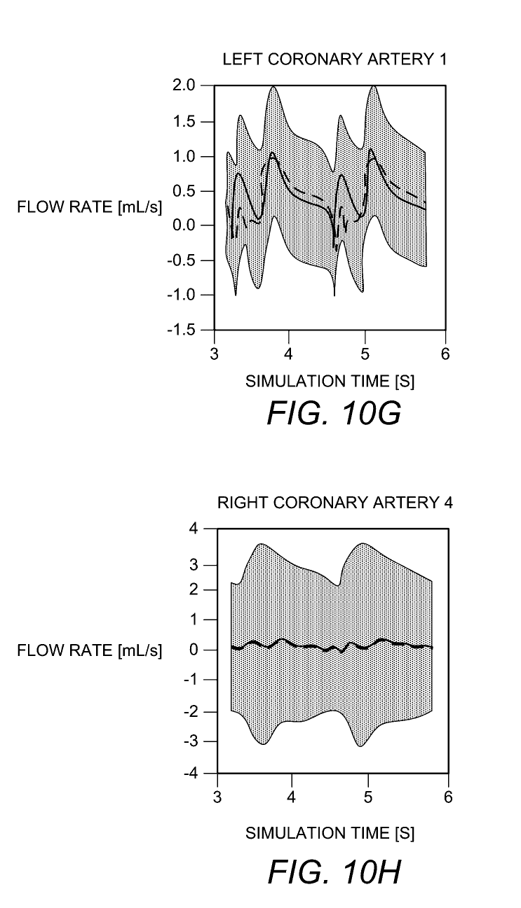

Parameters were selected using manual tuning to have a satisfactory agreement on a number of clinical targets, i.e., max/min aortic blood pressure, stroke volume, aorta/coronary blood flow split and flow split between right and left coronaries. Atrial and ventricular pressure-volume (PV) relationships were modeled using an activation function approach. A surrogate model for the three-dimensional coronary anatomy was initially computed by uniformly scaling the resistances of the RC blocks at each outlet. This scale factor was determined via manual iterations in order to achieve satisfactory approximations of multiscale pressure and flow rate time histories. Using these manually tuned resistances, flow rates at the generic i^{th} interface were determined as qᵢ=Rᵢ(pᵢₙₗₑₜ−pᵢ), where pᵢₙₗₑₜ is the pressure at the aortic inlet and Rᵢ the associated outlet resistance. Multiscale flow waveforms and regressions computed through OLS and RVM are shown in FIGS. 9A-9H and 10A-10H, respectively, at four selected interfaces, i.e., aortic outlet, first aortic branch, first left coronary artery outlet and fourth right coronary artery outlet. Due to qualitative similarity, OLS and RVM approximants were computed for several sampling ratios (0.05, 0.2 and 0.8) but are only shown for r=0.8.

### Integration of OLS and RVM Approximants in LPN Circulation Networks

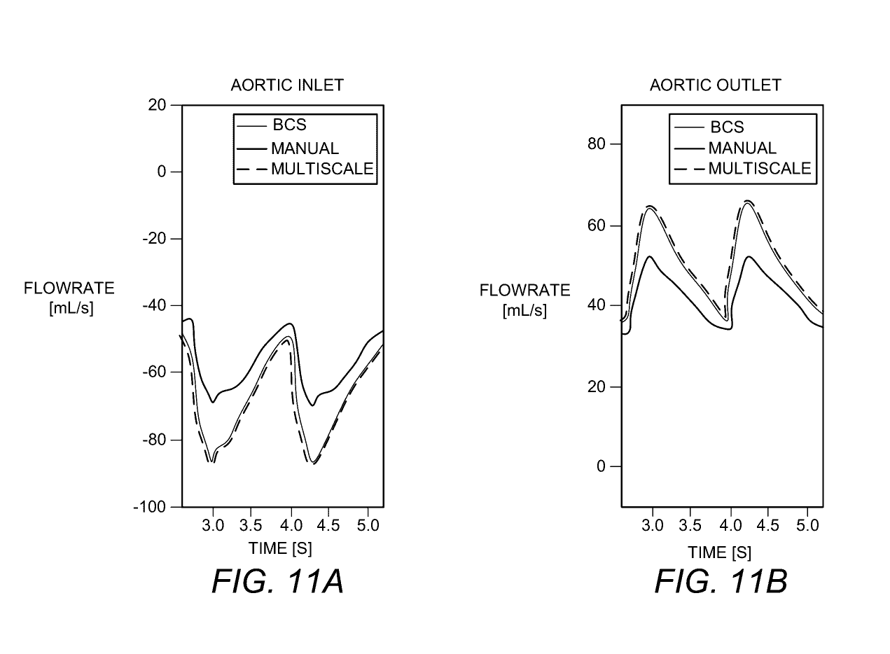

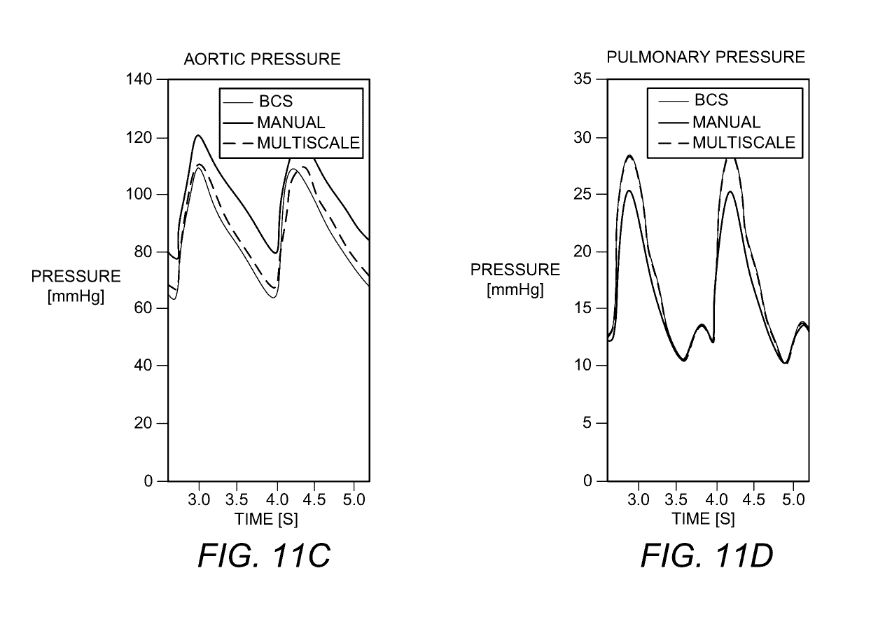

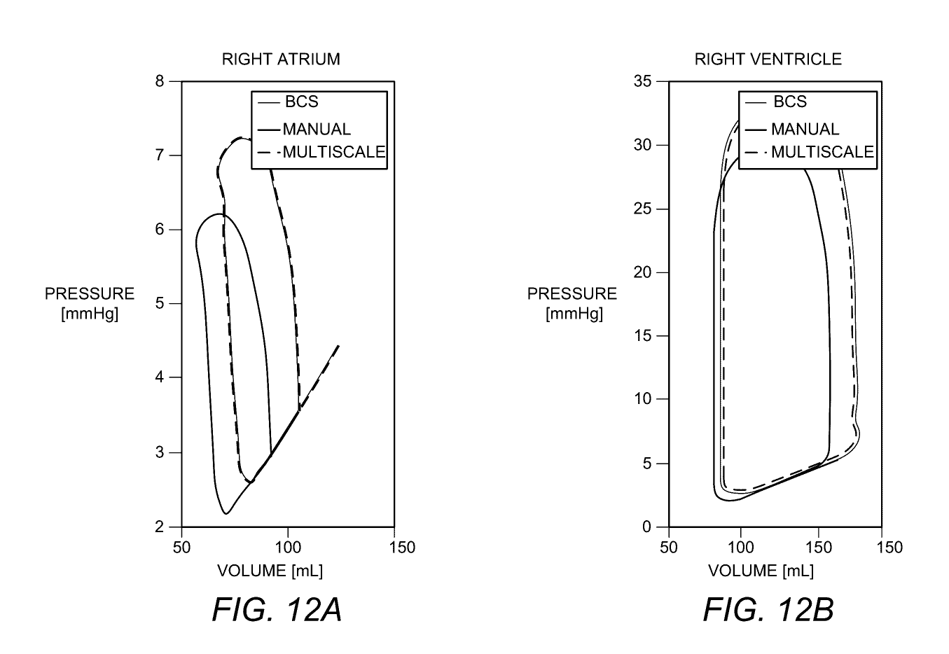

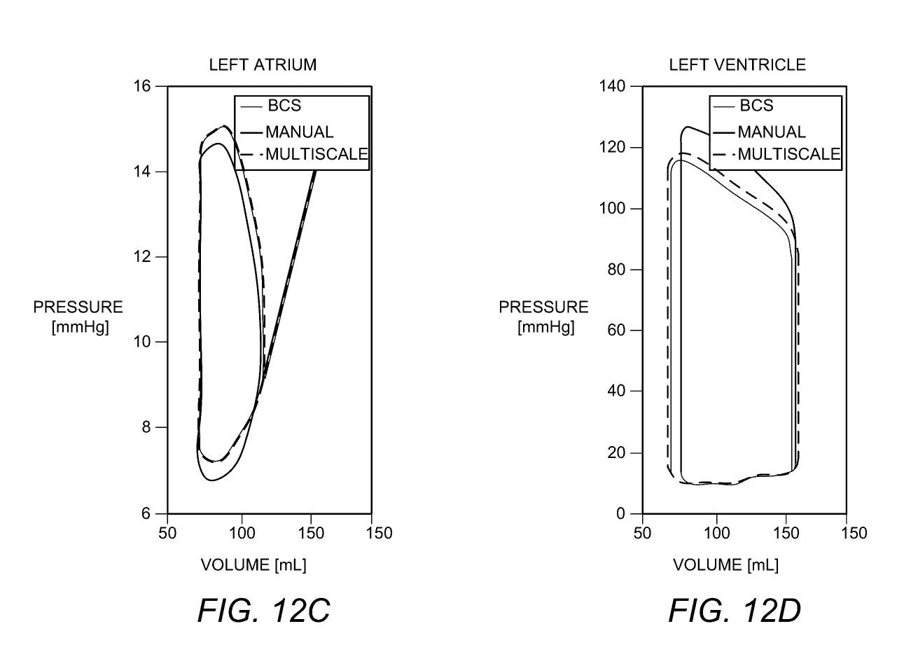

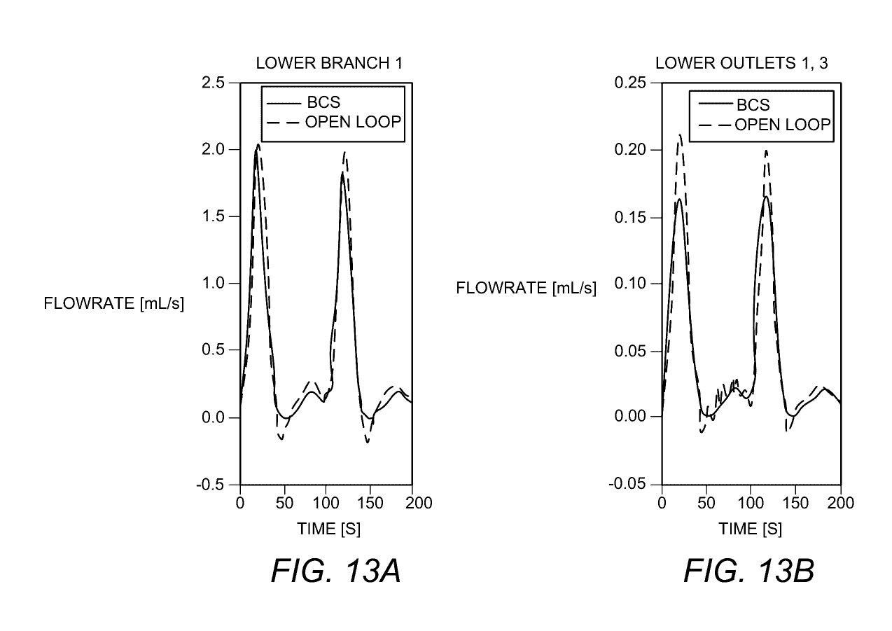

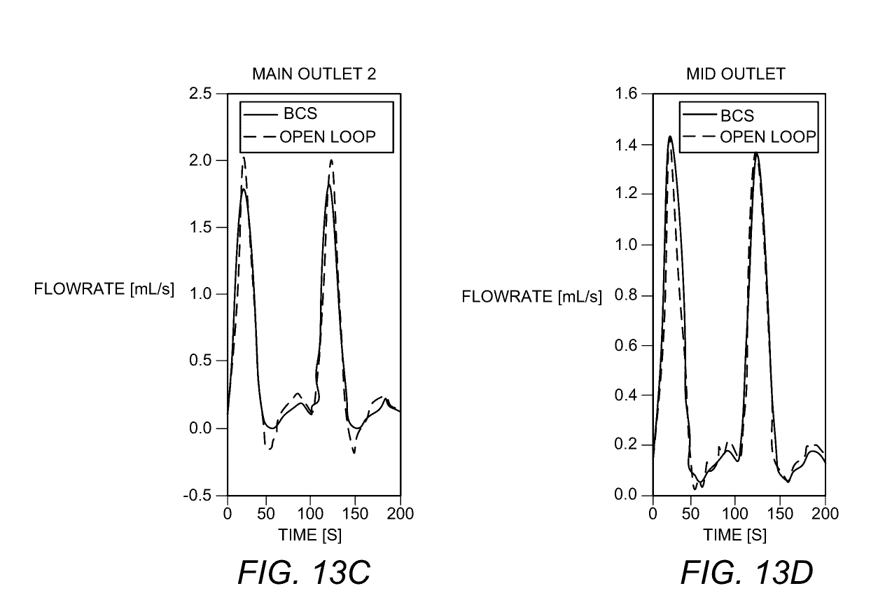

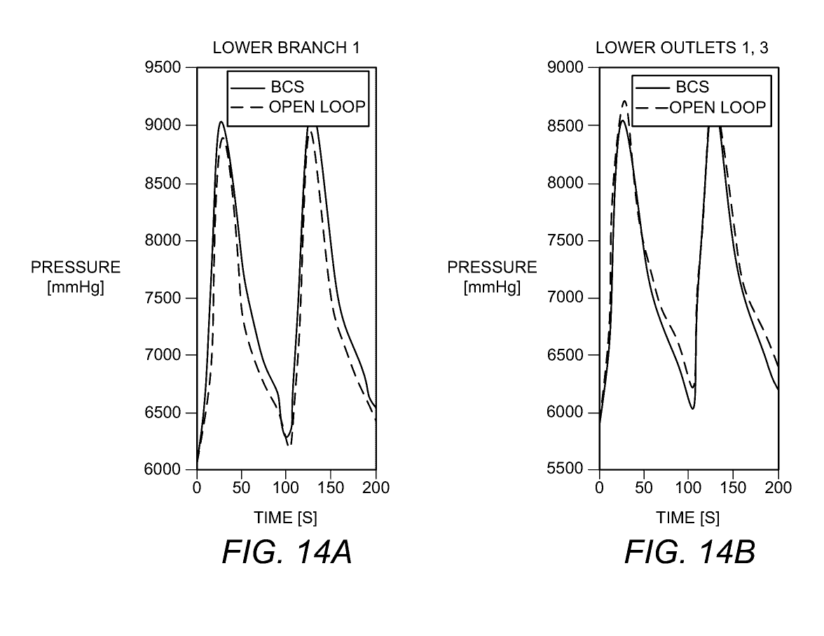

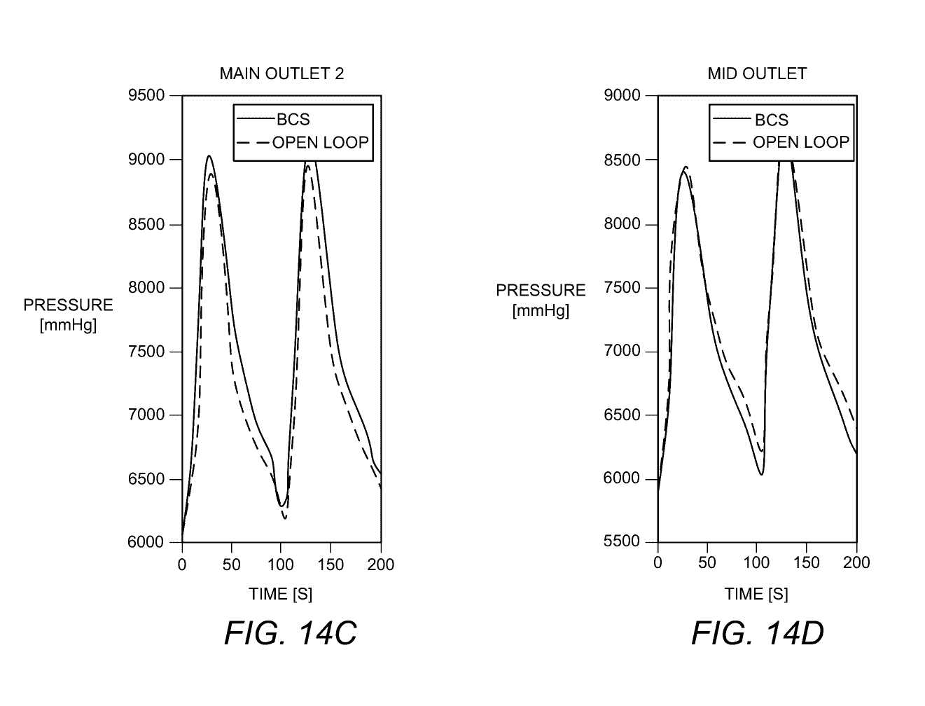

Integration of surrogate models into ODE solvers for circulation networks (a schematic idea of this is shown in FIG. 8) results in very different results for the two regression approaches. The adopted numerical approximation scheme (4th order Runge-Kutta approach with constant time step), rapidly diverges if coupled with an OLS surrogate, while the RVM approach leads to both working models and satisfactory agreement. Results comparing use of manually tuned resistances and the proposed RVM approximant are reported in FIGS. 11A-11D and 12A-12D for the coronary artery model, while FIGS. 13A-13D and 14A-14D refer to the abdominal aortic model.

### Computed Expansion Coefficients

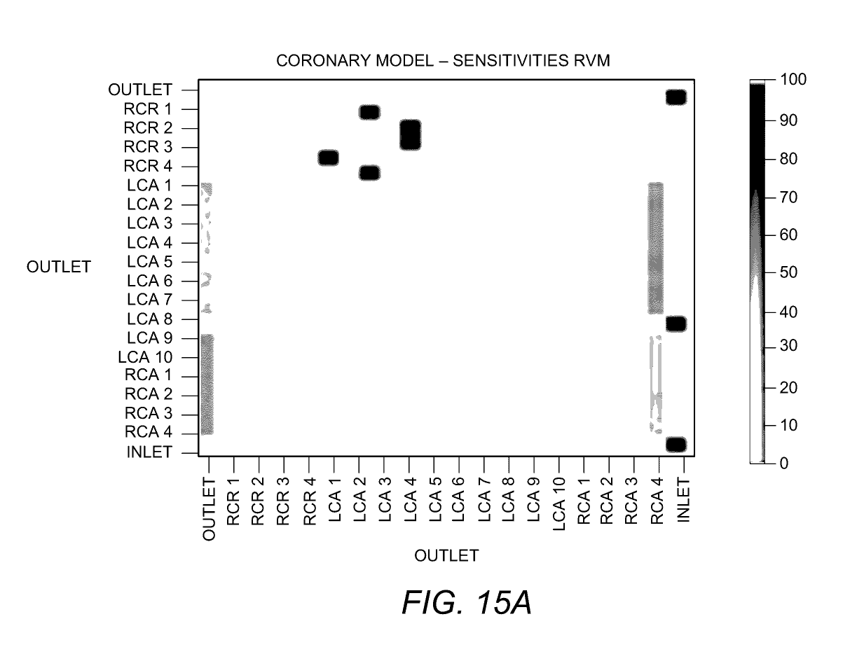

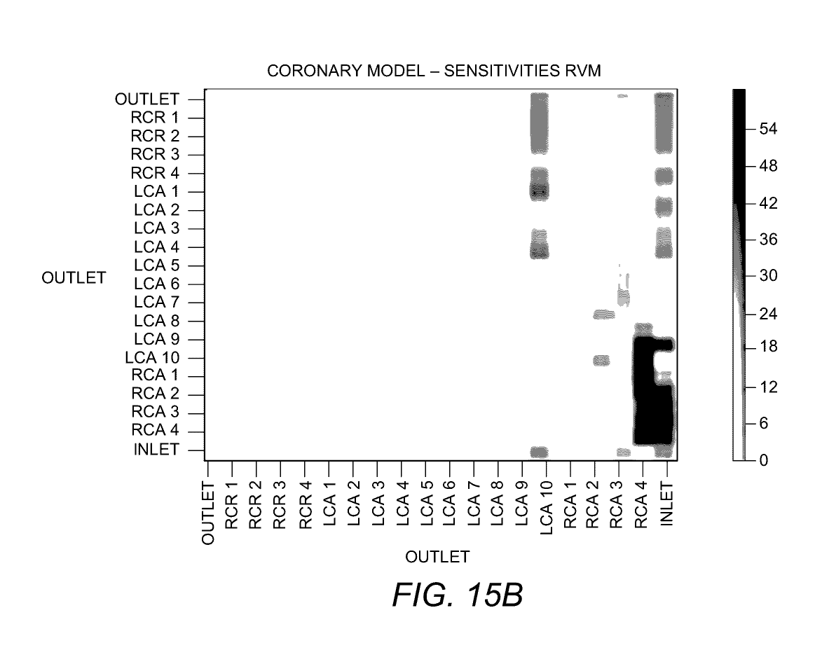

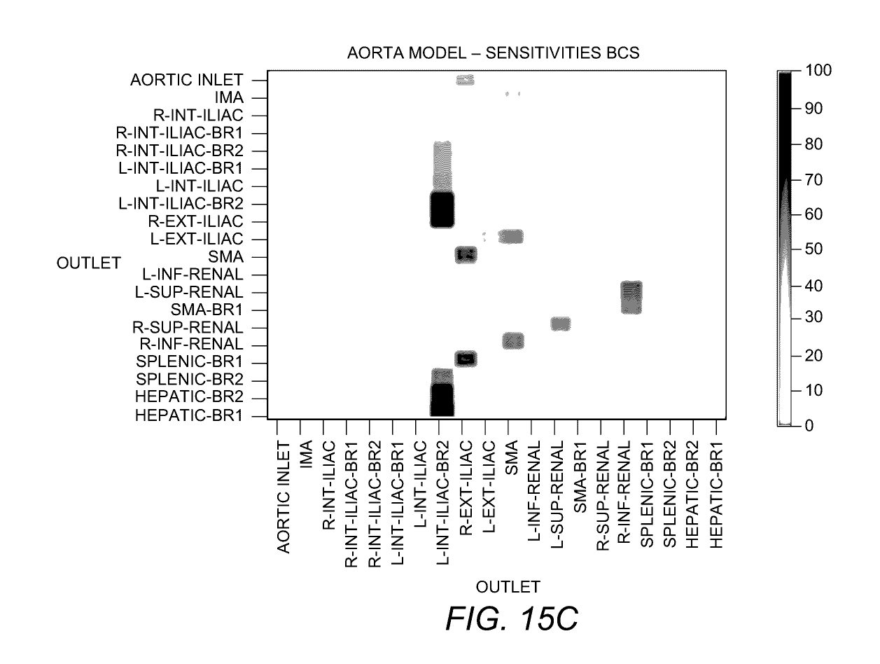

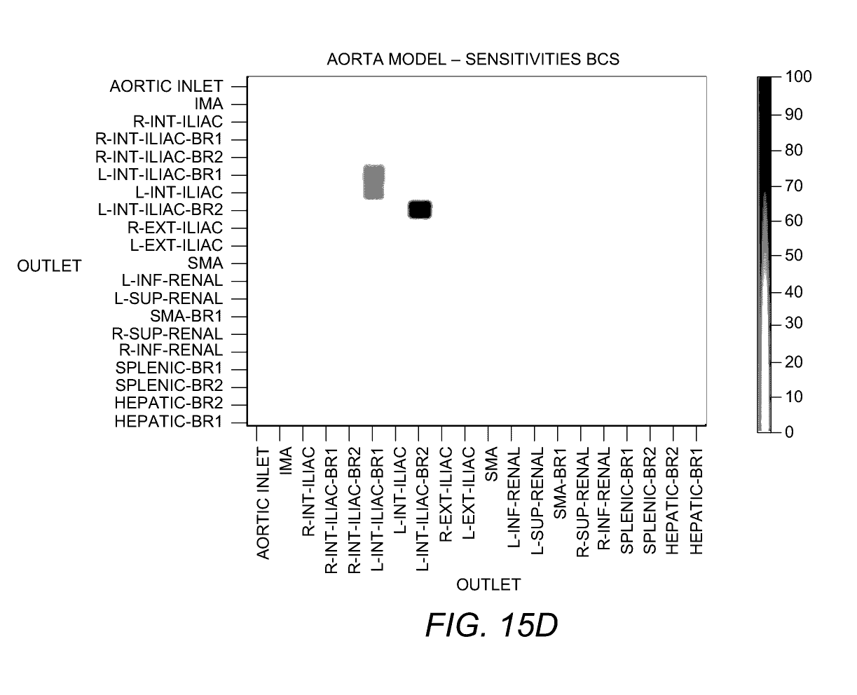

A decomposition of the normalized pressured-flow rate relation leads to a decomposition of the total variance in single parameter effects, combined effects of two parameters, three parameters, and so on. The combined global effect of the parameter set can therefore be quantified using a direct sensitivity index. FIGS. 15A-15D show outlet sensitivity matrices for abdominal aorta in coronary models. The sum in each row is equal to 100%, and darker colors indicate a more important contribution of the outlet in the associated column. The larger degree of sparsity obtained from relevant vector regression compared to maximum likelihood estimation is evident by comparing the color maps on the left and right, respectively.

### Propagation of Interface Pressure Perturbations

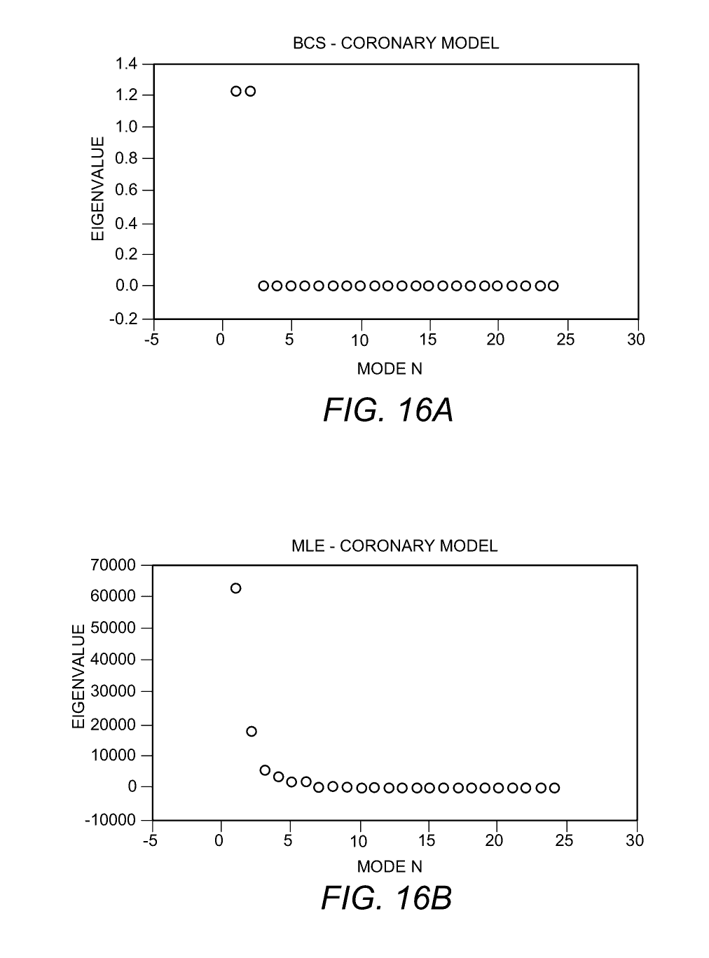

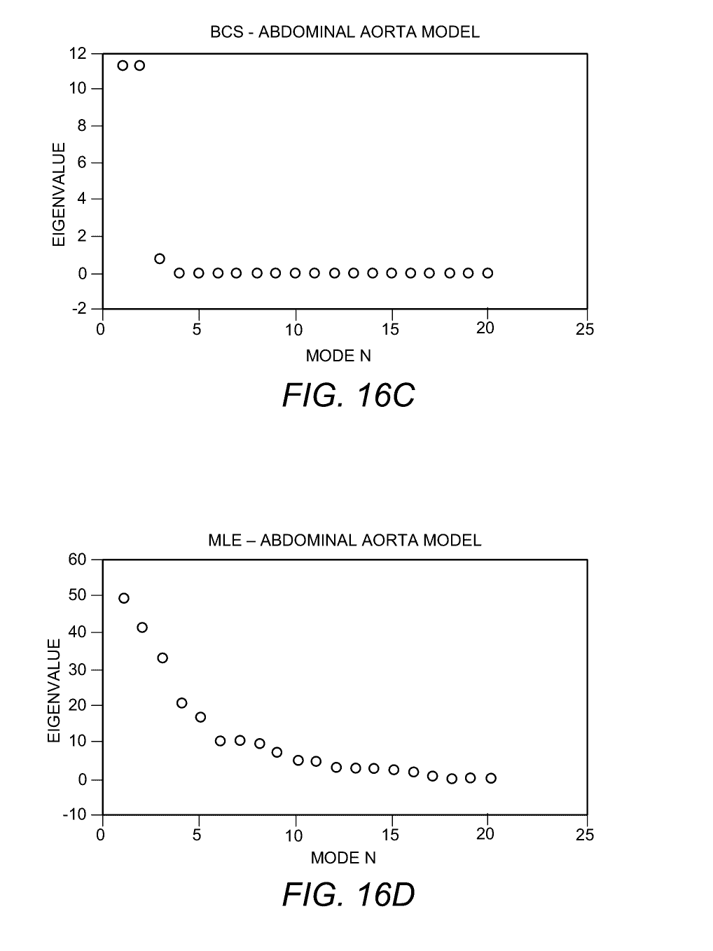

When considering stability of the computed reduced order representation, it has been found (see FIG. 16) that OLS regression produces significantly larger amplification factors than RVM and therefore it is likely for surrogate models produced by this technique to be less stable when included in ODE circulation models. Linear truncations of RVM regressors are also characterized by two modes with amplification factors greater than unity for both models. These eigenvectors are: an equal or opposite pressure perturbation in the aortic outlet and main right coronary artery in the first model. In the abdominal aortic model the same patterns apply to the main inlet and the outlet on the left superior renal artery.

### Example Implementation

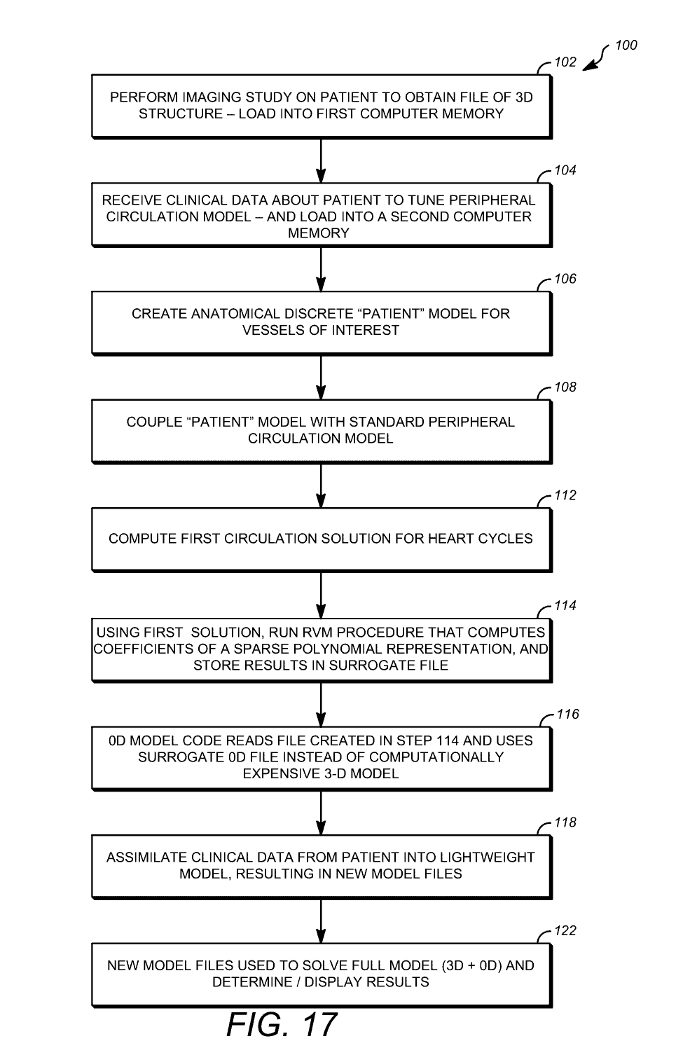

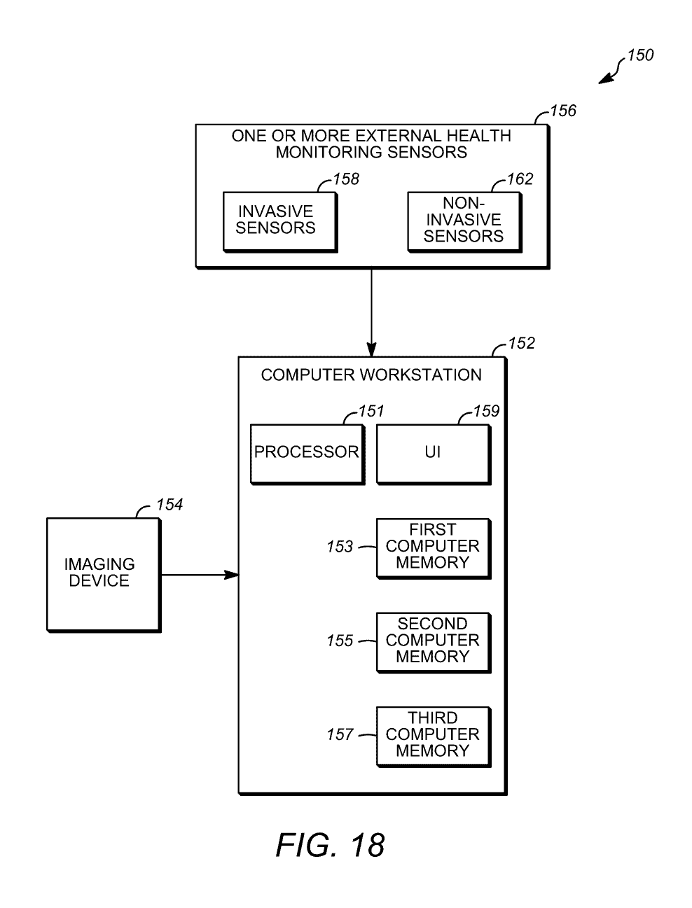

FIG. 17 is a flowchart 100 illustrating an exemplary method according to present principles for creating a three-dimensional model of the vascular hemodynamics of a patient, and FIG. 18 illustrates an exemplary system 150 for performing the method. The system 150 generally includes a computer workstation 152 in communication with one or more sensors 156 as well as an imaging device 154. Other devices will also be understood to be potentially in signal communication with the computer workstation 152.

The workstation 152 generally includes a processor 151 and several computer memories, such as first, second, and third computer memories 153, 155, and 157, respectively. Generally, data are loaded into the memories and operations are performed by the processor according to instructions stored on a computer readable medium, e.g., a non-transitory computer readable medium. It will be understood that the processor may include any number of processors in a multiprocessor system, as well as multiple threads were running within the same. Outputs, indications, representations of results, and the like, as well as a facility to enter data and other patient information, are facilitated by a user interface 159.

In addition, it will be understood that the computer workstation 152 is illustrated for simplicity and it is assumed that data may be entered by a user and data further may be received, from other devices, on the workstation 152. However, data from any of the devices may also be sent to a central server or other workstation prior to its transmission to the computer workstation 152. The central server or other workstation may perform steps including calibration, smoothing, or other data processing steps prior to the analysis, calculation, and computation, as described below, performed on workstation 152. And it will be understood that certain steps below may be performed in any order, e.g., the imaging study may be performed subsequent to the collection of clinical data about the patient.

As a first step, an imaging study is performed on the patient (step 102) by an imaging device 154, and the same generally results in a file or files constituting a 3-D model or structure of the vasculature. The imaging study is performed by a healthcare professional, and is generally performed using a known device 154, e.g., a device performing Computer Tomography (CT), CT Angiography (with injection of contrast) or MRI (either 3D or 4D) imaging. The images may be obtained preoperatively or postoperatively. The images may be focused on the anatomical location to be modeled. Where PC-MRI is employed, the same may also provide a velocity distribution that can later be correlated with the predicted hemodynamics.

In a next step, clinical data is entered or received about the patient, e.g., by the healthcare professional (HCP) (step 104). Such data, if user entered, is generally entered at a workstation. Data about the patient can also be obtained by direct sensor measurement from one or more health monitoring sensors, e.g., sensors 156, which can include invasive sensors 158 or noninvasive sensors 162. Such data are employed to tune the peripheral circulation model in order to provide a realistic representation of the overall hemodynamics. Such measurements include characterization of blood velocities/flow, volumes, collapsibility and veins, etc. Invasive pressure measurements may be obtained through catheterization, and noninvasive measurements include, e.g., Doppler echocardiography or MRI.

The number of measurements needed to tune a peripheral circulation model may vary depending on the patient characteristics or the associated pathology. For example, in a simulation of coronary artery disease, information on the heart function is generally more important than pressure and flow information about the pulmonary arteries and veins. Conversely, for a child affected by a severe form of congenital heart disease, e.g., single ventricle pathologies, data on the pulmonary circulation may be more important.

In a next step, the imaging data obtained in step 102 is employed to create an anatomical discrete “patient specific” model for the vessels of interest, e.g., using a software platform (step 106), e.g., a dedicated software platform such as SimVascular. In this step, the imaging data obtained in step 102 is essentially used to create a rough patient specific model of the vasculature.

The anatomical discrete patient model created in step 106 is then coupled with a standard peripheral circulation model (step 108), also known as a OD model, which depends on the specific pathology. For example, a standard peripheral circulation model exists for coronary artery disease, another for stage one single ventricle pathologies, and so on. The set of parameters for the standard model, e.g., may have been loaded into a second computer memory for this purpose, i.e., may be received, e.g., by the workstation 152, and loaded into a second computer memory. In more detail, this coupling may occur by, at every time step, the 3-D model writing the interface pressure/flow rate information in a file and calling a separate implementation of the OD model that reads this file and solves for the pressures that are, in turn, read back from the 3-D model.

To summarize, the results from the dedicated software platforms such as SimVascular provide the local “geometry” of the patient vasculature, while the OD model gives the ability to simulate the circulation in the rest of the body. In this regard it is noted that the OD model, i.e., the “standard peripheral circulation model,” is used to denote the preferred model for a certain application or disease.

In a next step, once the three-dimensional geometry has been made, e.g., using software such as SimVascular, and a OD model has been selected based on the disease of interest, the coupling may be performed by the solver in accordance with the calculations described here. In particular, using standard parameters for the above-noted OD model, a first circulation solution for the flow within the patient specific vasculature is computed for a number of various heart cycles (step 112), generally until the response is periodic, i.e., independent of the initial transient effects. This computational “run” may create two files, one file containing the flow rates (file “Q-general”), i.e., flow rate information, and one file containing the pressures (file “P-general”), i.e., pressure information, at at least one of, and in many cases all, the interfaces between the 3D and the OD model and at at least one of, and in many cases all, time steps. Here it is noted that the interfaces are the vessel cross-sections where the three-dimensional model ends and the OD model begins. The generic term “interface” is used to describe both model “inlets” (blood flowing in the 3-D model) as well as “outlets” (blood flowing out of the 3-D model).

Using the two files as inputs, a procedure such as the RVM procedure noted above is run, which computes the coefficients of a sparse polynomial representation of patient hemodynamics (step 114) based on the first circulation solution, e.g., and which may be saved in a file called, e.g., “RVM-surrogate”. In one example, this step takes a few seconds of computation time.

In a next step, the OD model code reads the “RVM-surrogate” file created in step 114 and is executed in a way that uses this surrogate, instead of the computationally expensive 3D model (step 116). A model with the surrogate takes only a fraction of a second to solve, and therefore optimization or estimation (typically requiring a significant number of model evaluations) can be performed in a reasonable time.

In a next step, using this “minimized” model of the patient vasculature, the clinical data for the patient is assimilated (step 118), in many cases automatically, and the results updated, e.g., an optimal estimate is determined for the OD model parameters together with their variability resulting from associating an uncertainty to the clinical data in step 104 (instead of considering them as “exact” quantities). The assimilation of the clinical data generally means that, from the knowledge of the patient clinical data, the OD model parameters are determined. For example, first a standard value of the OD model parameters may be used and then the best model parameters found via assimilation that will produce model outputs as similar as possible to the clinical measurements. This task is computationally expensive, and thus a minimized model is used, as described here, i.e., the OD model and the RVM surrogate. Details of such steps may be found in, e.g., U.S. Provisional Patent Application Ser. No. 62/336,430, filed May 13, 2016, entitled “Tulip: A Framework For Sensor Data Assimilation And Uncertainty Analysis Of Computer Models In Physiology”, incorporated by reference herein in its entirety. Files resulting from the procedure of step 118 generally contain multiple values (few 100K vectors) of the parameters compatible with the data compiled in step 104, as well as the estimated uncertainty.

Using the new files from step 118, a full model (3D+0D) is solved one or more times and the statistics, e.g., average value, standard deviation, and so on, of the model results are determined. In particular, in this step optimal parameters have been found through assimilation together with their distribution due to uncertainty. Thus it is only necessary to obtain the distributions of model results (outputs) from the distributions of model parameters (inputs). Once the distributions of model results are obtained, it is possible to characterize the uncertainty, e.g., the variance, of these quantities, and thus provide model predictions. Thus the results may then be employed to determine or identify one or more clinical indications or clinical diagnoses, and an indication of the second circulation solution and/or the clinical indication or diagnosis may be displayed on a user interface associated with the workstation 152. Such results may include, e.g.: distribution of blood pressure with time, which can be employed to identify anomalies such as hemodynamic significant stenosis, distribution of blood velocities and flow with time, which can be used to identify relevant flow reduction in some vessels, distribution of wall shear stresses, which are correlated with endothelial damage and thrombus formation, residence time, which is correlated with thrombus formation, and so on. Moreover, the change in these results between a pre-operative configuration and a “virtual” post-operative configuration can be used to justify competing surgical alternatives.

The system and method may be fully implemented in any number of computing devices. Typically, instructions are laid out on computer readable media, generally non-transitory, and these instructions are sufficient to allow a processor in the computing device to implement methods according to present principles. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a video graphics card or integrated graphics chipset coupled to a display that maybe seen by a user. Alternatively, a printer may be employed to output hard copies of the results. Given this teaching, any number of other tangible outputs will also be understood to be contemplated. For example, outputs may be stored on a memory chip, hard drive, flash drives, flash memory, optical media, magnetic media, or any other type of output. It should also be noted that the systems according to present principles may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or wi-fi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where vascular dynamics are modeled, the plural inputs may allow plural users to input relevant data at the same time.

1. A method for modeling behavior of 3D anatomical vasculature, comprising:
loading into a first computer memory data from a file indicative of a model of a patient's vasculature;
loading into a second computer memory data from one or more files indicative of a set of standard parameters indicative of pressure and flow rate characteristics of the vasculature;
calculating a first circulation solution for the model of the patient's vasculature using the data from the second computer memory and the data from the first computer memory, the first circulation solution including a solution for pressure, a solution for flow rate, or both;
calculating coefficients of a sparse polynomial representation of patient hemodynamics based on the first calculated circulation solution, and creating a surrogate file with the calculated coefficients;
loading into a third computer memory a minimized model of the patient's vasculature using the calculated coefficients from the surrogate file;
receiving one or more data from one or more respective health monitoring sensors, and modifying the minimized model based on the received one or more data;
calculating a second circulation solution for the minimized model; and
determining one or more clinical indications from the calculated second circulation solution, and displaying a representation of the determined indication on a user interface.

2. The method of claim 1, wherein the loading into a first computer memory data from a file indicative of the model of a patient's vasculature includes receiving an image file of the patient's vasculature, and creating a 3D model of the patient's vasculature based on the received image file.

3. The method of claim 2, wherein the loading into a first computer memory data from a file indicative of the model of a patient's vasculature includes receiving data from an MRI machine.

4. The method of claim 3, further comprising the step of correlating the second circulation solution with a velocity distribution from the received data from the MRI machine.

5. The method of claim 1, wherein the set of standard parameters is from a standard peripheral circulation model.

6. The method of claim 1, wherein the step of calculating the coefficients is performed using a relevance vector machine (RVM) methodology.

7. A non-transitory computer readable medium, comprising instructions for causing a computing environment to perform the method of claim 1.

8. A method for modeling behavior of 3D anatomical vasculature using an outlet pressure-flow rate approximation, comprising:
a. creating a lumped circulation model based on a 3D model of vasculature; and
b. creating a finite element model and a boundary circulation network, with coupling occurring at an interface between the finite element model and the boundary circulation network, and such that data indicative of pressure/flow rate information is exchanged at at least one solution time step.

9. The method of claim 8, wherein the data indicative of outlet pressure/flow rate information is approximated by outlet pressure/flow rate functional surrogates.

10. The method of claim 9, further comprising using a sparse regression approach to promote small expansion coefficients through properly selected hyperpriors.

11. The method of claim 10, wherein the sparse regression approach includes using relevance vector machines.

12. The method of claim 8, further comprising receiving the 3D model of vasculature, and performing the step of creating the lumped circulation model from the received 3D model.

13. The method of claim 8, wherein the lumped circulation model receives outlet flow rates from the finite element model and wherein the lumped circulation model further provides pressure information back at respective outlets for a subsequent time step.

14. The method of claim 8, wherein the 3D model receives outlet pressures from the lumped circulation model and further comprising providing an updated local distribution of pressures and velocities, resulting in new outlet flow rates.

15. The method of claim 8, wherein the finite element model and the boundary circulation network exchange pressure and flow rate information, such that the lumped circulation model is reduced while preserving the exchange of information at the interface.

16. A non-transitory computer readable medium, comprising instructions for causing a computing environment to perform the method of claim 8.
